(19) United States
(12) Patent Application Publication
(10) Pub. No.: US 2002/0020658 A1
(43) Pub. Date: Feb. 21, 2002

(54) Drain filter support

(76) Inventor: Ronald Isaacson, Morganville, NJ (US)

Correspondence Address: ROBERT M. SKOLNIK, 353 Monmouth Road, PO Box 22, West Long Branch, NJ, 07764-0022, US

(21) Appl. No.: 09/829,211

(22) Filed: Apr. 9, 2001

Related U.S. Application Data
(63) Continuation of application No. 09/411,279, filed on Oct. 4, 1999, now Pat. No. 6,214,216.

(51) Int. Cl. B01D 29/05; B01D 35/02

(52) U.S. Cl. 210/162; 210/163; 210/164; 210/232; 210/484; 404/4

(57) ABSTRACT

A catch basin insert or filter is supported in an open type curb inlet storm drain found on streets and in parking lots. Catch basin filters and inserts are designed to collect coarse sediments, oil, grease and debris from storm water runoff. Such filters normally require support on all four sides of a grate using the weight of the grate. A loop and rod attaches one or more sides of a filter or insert inside a curb inlet storm sewer vault instead of using the weight of the grate.

### CROSS REFEREMCE TO RELATED APPLICATIONS

This application is a continuation of my co-pending application Ser. No. 09/411,279, filed Oct. 4, 1999, now U.S. Pat. No. 6,214,216, issued Apr. 10, 2001.

### BACKGROUND OF THE INVENTION

1. Field of the Invention

The present invention relates to a drain filter support. The support of the present invention modifies the known drain filter sold under the trademark DRAIN DIAPER® so that is can be used with curb and other drains without the need to support the filter about the entire periphery of the drain cover.

2. Description of the Related Art

Sewer drain filters are taught in several prior art patents.

Boosey U.S. Pat. No. 2,263,259 discloses a self-cleaning sewer drain where the catch bag 15 is supported around the entire diameter of the pipe 13.

Arntyr, et al., U.S. Pat. No. 4,419,232 disclose a collection bag supported by hooks formed on an insert. Round and rectangular versions are shown.

Murfae, et al., U.S. Pat. No. 5,133,619, relates to a special construction for a storm drain.

Logue, U.S. Pat. Nos. 5,373,714 and 5,575,926 has carrying loops 34 are formed in the edges of the filter bag and lift rods 40 are inserted into the loops.

Schneider, U.S. Pat. No. 5,405,539 discloses the use of pneumatic cylinders 34 and 35 to support a filter structure in storm drain housing. This is best seen in FIG. 2.

Chinn, et al., U.S. Pat. No. 5,725,782, FIG. 7, attaches the bag type roll filter to a curb drain with straps 32 or hood 37.

Fanelli, U.S. Pat. No. 5,733,445, installs a special covering grate and filter assembly over an existing grate. The filter assembly is supported in the covering grate as shown in FIGS. 4 and 6.

Stetler, U.S. Pat. No. 5,744,048 requires a specially configured filter 70 so that the filter can be supported on a support element fabricated as part of a storm drain insert.

### SUMMARY OF THE INVENTION

The invention is a modification to the known DRAIN DIAPER® drain filter to enable the filter to be used in drains with the need to support the filter about the entire periphery of the grate. The modification involves the formation of one or more loops on one or more edges of the filter and inserting a spring loaded rod in the loop so that the rod supports the side in the drain housing. In one embodiment of the invention, this support also creates a dam of filter material to prevent debris from entering the mouth of a curb drain.

The present invention supports a catch basin insert or filter in an open type curb inlet storm drain found on streets and in parking lots. Catch basin filters and inserts are designed to collect coarse sediments, oil, grease and debris from storm water runoff. Such filters require support on all four sides of a grate using the weight of the grate. The present invention attaches such a filter or insert inside a curb inlet storm sewer where only three sides of a grate are available for support. The invention may also be used to support the insert or filter within the drain vault without the need to support the insert using the weight of the grate.

The present invention modifies the filter by creating a reinforced pocket on one or more side length of the filter/insert. The pocket(s) accommodates a spring-loaded adjustable heavy-duty rod. The rod is placed inside the pocket and adjusted in length to fit inside the curb inlet drain and/or inside the vault. The rod is then positioned against each sidewall inside the curb drain or vault so that it is secured tightly against the sidewalls. The rod may be adjustable in length and in spring force exerted within the curb drain or the vault. The other sides of the filter without the pockets are supported by the weight of the grate.

The present invention also provides a vertical barrier or dam on the open curbside of the catch basin to prevent debris from falling behind the filter/insert into the basin.

A principal object and advantage of the invention is the provision of a drain filter for catch basins.

Another object and advantage of the invention is the provision of a curb drain filter for curbside catch basins, which inhibits debris, etc. from entering the open portion of the catch basin.

A still further object of the invention is the provision of a curb drain filter that modifies an existing filter so that is can be used in curb drains.

Another object and advantage of the invention is the provision of curb drain support, which is adjustable so that it can be used in curb drains of different dimensions.

A still further object and advantage of the invention is the provision of a drain filter support, which does not require use of the storm drain grate.

Another object and advantage of the invention is the provision of a drain filter support, which does not require use of a drain grate to hold the filter.

The foregoing, as well as further objects and advantages of the invention will become apparent to those skilled in the art from a review of the following detailed description of my invention, reference being made to the accompanying drawings.

### BRIEF DESCRIPTION OF THE DRAWINGS

FIG. 1 is an exploded perspective view of my invention;

FIG. 2 is a perspective view of the device shown in FIG. 1 in use at a curb drain;

FIG. 3 is an assembly view of the device shown in FIG. 1.

FIG. 4 is a perspective view of a modification to the device shown in FIGS. 1-3.

### DETAILED DESCRIPTION OF THE PREFERRED EMBODIMENT

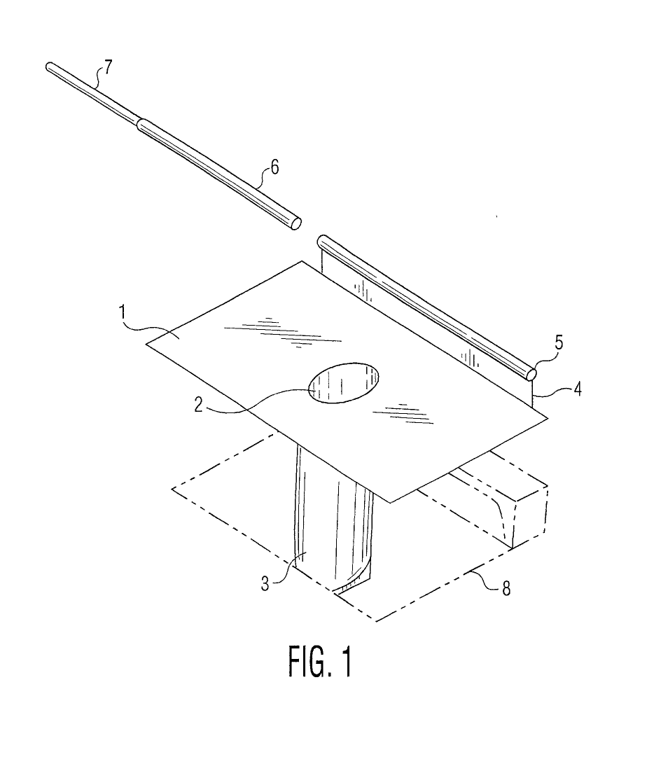

As shown in FIGS. 1-3, where like reference numerals are used to designate like parts, the drain filter has a collection bag 3 attached to a rectangular (or other shape) filter portion 1. A loop 5 is formed on one side of the portion 1 creating a wall 4 of filter material. A rod having two portions 6 and 7 fits within loop 5. The rod may be a spring-loaded rod so that portions 6 and 7 may be adjusted in length.

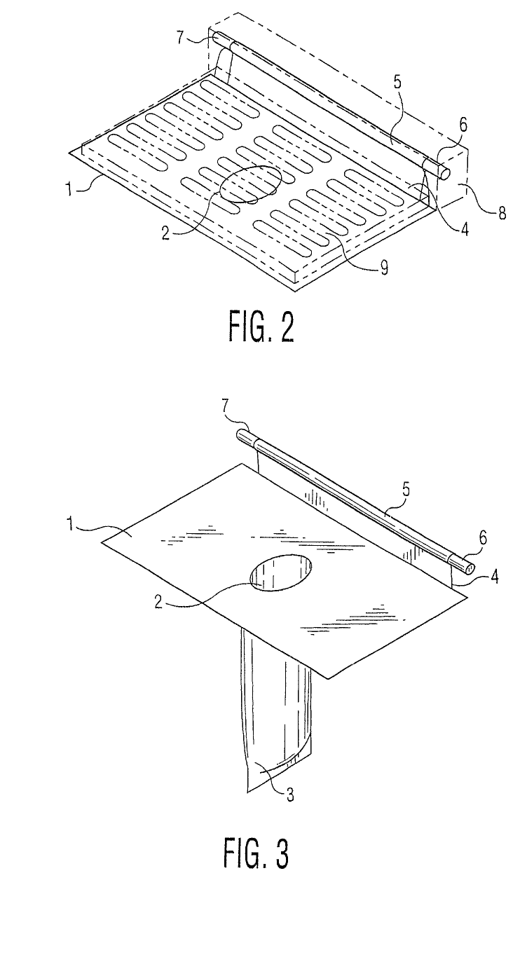

As shown in FIGS. 1-2, the curb drain 8 has a grate 9 covering same as is well know. An opening between the grate surface and the curb is also known. In use, the grate 9 is removed, filter portion 1 with the bag 3 is placed in the drain, and the grate 9 replaced with the sides of the portion 1 held in placed by the weight of the grate 9. The rod is then inserted into the loop 5 and adjusted to firmly seat within the internal vault structure of the curb drain. Portion 4 is then extended upwards forming a dam to block debris from entering the drain vault though the opening.

As is known in the art, the drain filter shown at numerals 1-3 may be made of materials known in the prior art, which are permeable to water, but impermeable to other liquids and solids.

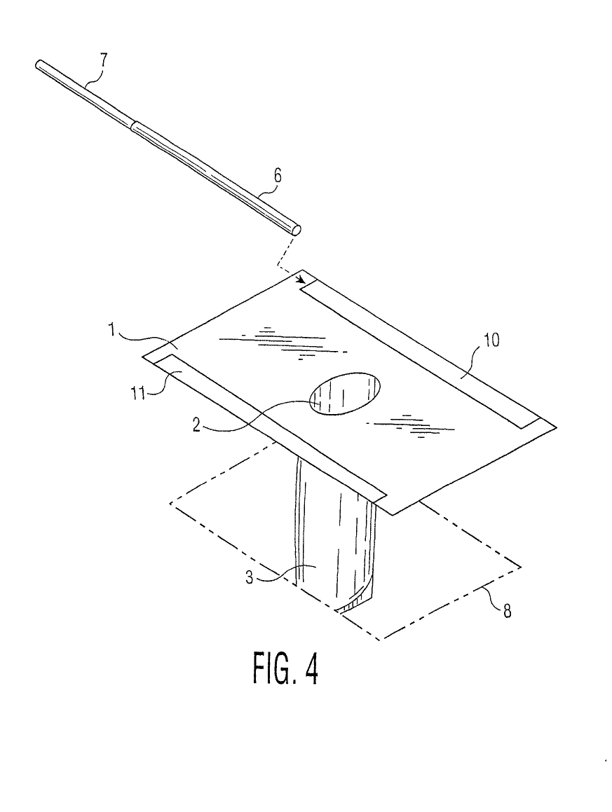

Other sides of the drain filter may be supported in the vault by formation of loops on the other sides of the drain filter and employing spring-loaded rods in those lops to support the filter within the vault against the sidewalls of the vault. As shown in FIG. 4, in which like reference numerals are used to denote like parts from FIGS. 1-3, additional pockets or sleeves such as 10 and 11 are formed on the edges of the filter portion 1. These sleeves or pockets receive spring-loaded rod for supporting that side of the DRAIN DIAPER® beneath the grate against the walls of the storm drain vault. The filter insert is thus independent of support by the weight of the grate. The sleeves or pockets 10 and 11 may be used at one, two, three or all sides of the filter insert.

Further modifications to the apparatus of the invention may be made without departing from the spirit and scope of the invention; accordingly, what is sought to be protected is set forth in the appended claims.

What is claimed is:

1. A drain filter comprising: a collection bag; a loop formed at one or more portions of said collection bag; rod means inserted in each of said loops for supporting said collection bag in a drain vault by attaching said rod means in a drain vault.

2. In a drain filter having a collection bag, the improvement comprising: pocket means formed at one or more ends of said collection bag for receiving an adjustable support therein and mounting means connected to said adjustable support for supporting said collection bag against internal portions of a drain; said mounting means being attached to said internal portions of a drain.

3. The drain filter of claim 2 further including a portion of said collection bag forming a dam to inhibit debris from entering a drain.

4. A drain filter having a collection bag; a pocket formed on at least two sides of said collection bag; adjustable length rods mounted in said pockets for mounting said collection bag within a storm drain by attaching said rods within said storm drain.

5. The drain filter of claim 4 further including a portion of said collection bag connected to one of said pockets for forming a dam preventing debris from entering a storm drain.

6. In a drain filter, means to support the drain filter in a storm drain comprising at least two loop pockets formed on opposite sides of said drain filter and rod means mounted in each of said loop pockets for mounting said filter in a storm drain by connecting said rod means to internal portions of a storm drain.

7. The apparatus of claim 6 wherein said rod means is adjustable in length.

8. The method of mounting a drain filter in a drain vault comprising the steps of forming at least two loops in a drain filter, inserting a rod into each of said loops, and connecting said rods to internal portions of said drain vault.

9. The method of claim 7 wherein each of said rods may be adjustable in length and further including the step of adjusting the length of said rods to connect them to said internal portions of said drain vault.
